(19) United States
(12) Patent Application Publication
(10) Pub. No.: US 2018/0032201 A1
(43) Pub. Date: Feb. 1, 2018

(54) DISPLAY APPARATUS AND METHOD OF CONTROLLING THE SAME

(71) Applicant: SAMSUNG ELECTRONICS CO., LTD., Suwon-si (KR)

(72) Inventors: Bong Min SONG, Suwon-si (KR); Seong Jun KIM, Suwon-si (KR); Hyun Joo HAN, Yongin-si (KR)

(21) Appl. No.: 15/605,022

(22) Filed: May 25, 2017

(30) Foreign Application Priority Data
Jul. 29, 2016 (KR) 10-2016-0096860

(51) Int. Cl. G06F 3/041; G06F 3/044

(52) U.S. Cl. CPC G06F 3/0416; G06F 3/044; G06F 2203/04105

(57) ABSTRACT

It is an aspect of the present disclosure to provide a display apparatus having an optical clear adhesive (OCA) layer provided such that a permittivity of the OCA layer is changed when a pressure is applied and a method of controlling the same. In accordance with one aspect of the present disclosure, a display apparatus includes: a touch panel; a cover glass disposed at an upper side of the touch panel; a display disposed at a lower side of the touch panel; and an optical clear adhesive (OCA) layer disposed between the touch panel and the cover glass to bond the touch panel and the cover glass, wherein the OCA layer is provided such that a permittivity of the OCA layer is changed when a pressure is applied.

### CROSS-REFERENCE TO RELATED APPLICATION

This application is based on and claims priority under 35 U.S.C. § 119 to Korean Patent Application No. 10-2016-0096860, filed on Jul. 29, 2016 in the Korean Intellectual Property Office, the disclosure of which is incorporated by reference in its entirety.

### BACKGROUND

### 1. Technical Field

The present disclosure relates generally to a display apparatus.

### 2. Description of the Related Art

Generally, a touch screen panel refers to a screen that may directly receive a user's command by determining a character displayed on the screen or a specific position at which a part of the user's body reaches (touches) without using a keyboard. Such a touch screen panel may reduce a size of a product by integrally providing a display device and an input device, and is thus widely used in portable electronic devices.

Touch screen panels may be divided into a resistive type, a capacitance type, an infrared type, and an ultrasonic type according to a method of receiving a user's command.

In a resistive-type touch screen panel, a dielectric (an insulator) is provided between two electrically separated electrodes. When the panel is touched by a part of a user's body, pressure is generated, and resistive films may come in contact with each other due to this pressure. The resistive-type touch screen panel senses the user's touch by sensing a change of an electrical resistance between the two electrodes due to the contact of these resistive films.

In a capacitance type touch screen panel, a dielectric (an insulator) is provided between two electrically separated electrodes. Also, the capacitance type touch screen panel senses a user's touch by sensing a change of a capacitance between the two electrodes caused by a part of the user's body touching the panel.

### SUMMARY

Therefore, it is an aspect of the present disclosure to provide a display apparatus having an optical clear adhesive (OCA) layer provided such that a permittivity of the OCA layer is changed when a pressure is applied, and a method of controlling the same.

Additional aspects of the disclosure will be set forth in part in the description which follows and, in part, will be obvious from the description, or may be learned by practice of the disclosure.

In accordance with one aspect of the present disclosure, a display apparatus includes: a touch panel; a cover glass disposed at an upper side of the touch panel; a display disposed at a lower side of the touch panel; and an optical clear adhesive (OCA) layer disposed between the touch panel and the cover glass to bond the touch panel and the cover glass, wherein the OCA layer is provided such that a permittivity of the OCA layer is changed when a pressure is applied.

The OCA layer may include at least one layer having conductive particles so that the permittivity is changed when the pressure is applied.

The OCA layer may include conductive particles dispersed therein so that the permittivity is changed when the pressure is applied.

The OCA layer may include a polar material so that the permittivity is changed when the pressure is applied.

The OCA layer may include a polyvinylidene fluoride (PVDF) so that the permittivity is changed when the pressure is applied.

The display apparatus may further include a controller, when a touch command for the cover glass is input, configured to determine the touch command as a touch command including the pressure operation when a change in the capacitance of the touch panel is larger than a predetermined reference value and determine the touch command as a touch command without the pressure operation when the change in the capacitance of the touch panel is less than the predetermined reference value.

When the touch command is determined to be the touch command including the pressure operation, the controller, in response to the pressure operation, may be configured to perform a predetermined control different from a control according to the touch command without the pressure operation.

In accordance with another aspect of the present disclosure, a method for controlling a display apparatus includes: determining whether a change in capacitance of a touch panel of the display apparatus is larger than a predetermined first reference value when a touch command to the display apparatus is input; and determining the touch command as a touch command including a pressure operation when the change in the capacitance is larger than the first reference value.

The method may further include performing a predetermined control in response to the pressure operation when the touch command is determined to be the touch command including the pressure operation.

The method may further include performing a predetermined control, in response to the pressure operation, different from a control according to the touch command without the pressure operation when the touch command is determined to be the touch command including the pressure operation.

The method may further include determining the touch command as a touch command without a pressure operation when the change in the capacitance is less than the first reference value.

In accordance with another aspect of the present disclosure, an input apparatus includes: a touch panel; a cover glass disposed at an upper side of the touch panel; and an optical clear adhesive (OCA) layer disposed between the touch panel and the cover glass to bond the touch panel and the cover glass, wherein the OCA layer is provided such that a permittivity of the OCA layer is changed when a pressure is applied.

The OCA layer may include at least one layer having conductive particles so that the permittivity is changed when the pressure is applied.

The OCA layer may include conductive particles dispersed therein so that the permittivity is changed when the pressure is applied.

The OCA layer may include a polar material so that the permittivity is changed when the pressure is applied.

The OCA layer may include a polyvinylidene fluoride (PVDF) so that the permittivity is changed when the pressure is applied.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating a structure of a display apparatus in accordance with one embodiment of the present disclosure.

FIGS. 2A, 2B and 2C are diagrams illustrating a structure of an optical clear adhesive (OCA) layer of the display apparatus in accordance with one embodiment of the present disclosure.

FIG. 3 is a view conceptually illustrating capacitance when a touch command is not inputted to the display apparatus in accordance with one embodiment of the present disclosure.

FIG. 4 is a view conceptually illustrating capacitance when a touch command without a pressure operation is input to the display apparatus in accordance with one embodiment of the present disclosure.

FIG. 5 is a view conceptually illustrating capacitance when a touch command including the pressure operation is input to the display apparatus in accordance with one embodiment of the present disclosure.

FIG. 6 is a view conceptually illustrating capacitance when a pressure operation is input by a non-conductive tool to the display apparatus in accordance with one embodiment of the present disclosure.

FIG. 7 is a block diagram illustrating a control configuration of the display apparatus in accordance with one embodiment of the present disclosure.

FIG. 8 is a flowchart illustrating a method of controlling the display apparatus in accordance with one embodiment of the present disclosure.

### DETAILED DESCRIPTION

Like numbers refer to like elements throughout this specification. This specification does not describe all components of the embodiments, and general information in the technical field to which the present disclosure belongs or overlapping information between the embodiments will not be described. The terms “part, module, member and block”, as used herein, may be implemented as software or hardware, and according to embodiments, a plurality of “part, module, member and block” may be implemented as a single component, or a single “part, module, member and block” may include a plurality of components.

Throughout this specification, when a part is referred to as being “connected” to another part, it includes not only a direct connection but also an indirect connection. And the indirect connection includes connection through a wireless communication network do.

Also, it will be understood that when the terms “includes,” “comprises,” “including,” and/or “comprising,” when used in this specification, specify the presence of a stated component, but do not preclude the presence or addition of one or more other components.

Throughout this specification, when a member is disposed at an upper side of the other member, this includes not only the case where the member is in contact with the other member, but also the case where there is another member between the two members.

The terms first, second, etc. are used to distinguish one element from the other, and the elements are not limited by the above-mentioned terms.

It is to be understood that the singular forms “a,” “an,” and “the” include plural referents unless the context clearly dictates otherwise.

Reference numerals used in operations are provided for convenience of description, without describing the order of the operations, and the operations can be executed in a different order from the stated order unless a specific order is definitely specified in the context.

Hereinafter, the operation principle and embodiments of the present disclosure will be described with reference to the accompanying drawings.

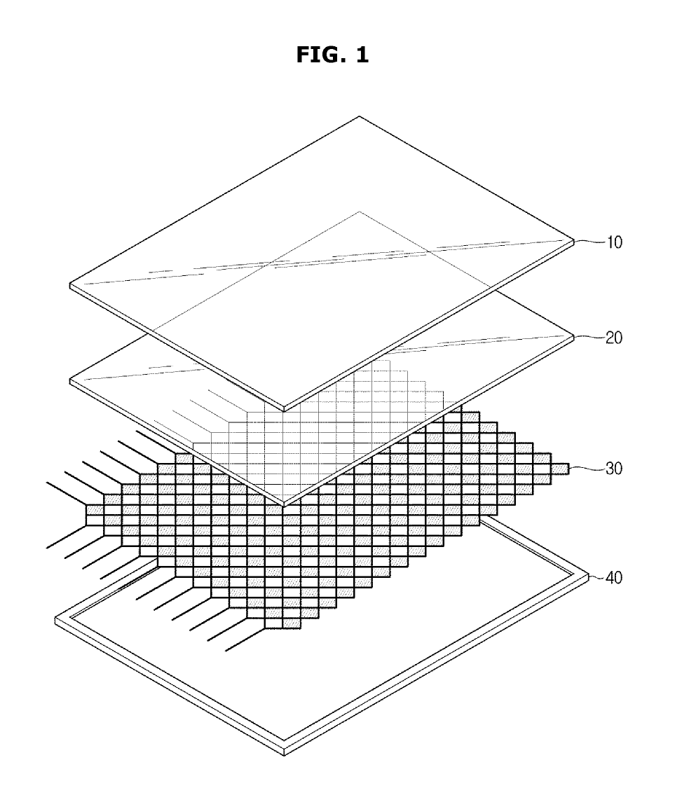

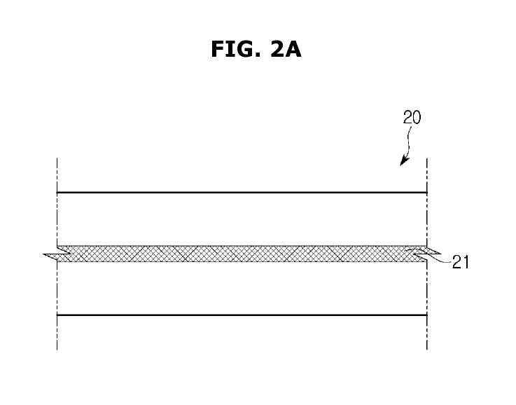

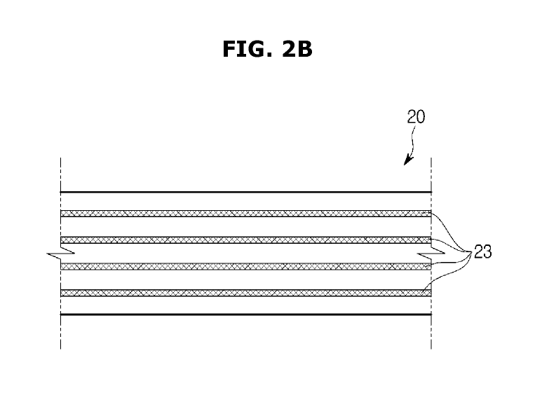

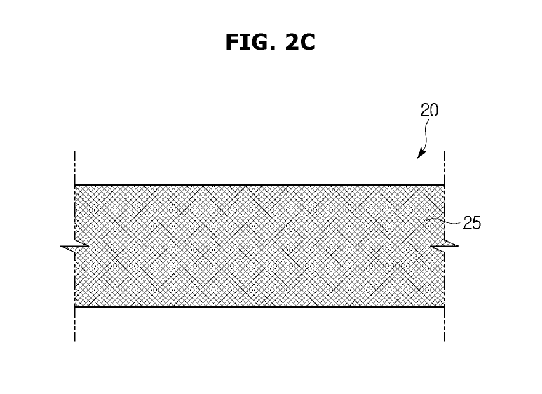

FIG. 1 is a view illustrating a structure of a display apparatus in accordance with one embodiment of the present disclosure. FIGS. 2A to 2C is a view illustrating a structure of an optical clear adhesive (OCA) layer of the display apparatus in accordance with one embodiment of the present disclosure.

Throughout this specification, the display apparatus may be embodied as a computer or a portable terminal having a display capable of displaying information. The computer includes, for example, a laptop, a desktop, a tablet PC, a slate PC, and the like with a web browser (WEB Browser). The portable terminal is a wireless communication device that ensures portability and mobility. For example, the portable terminal may include all kinds of handheld-based wireless communication devices such as a smart phone and a wearable device such as a watch.

As illustrated in FIG. 1, the display apparatus in accordance with one embodiment of the present disclosure may include a display 40, a touch panel 30 disposed at an upper side of the display 40, a transparent cover glass 10, an optical clear adhesive (OCA) layer 20 provided to bond the touch panel 30 and the cover glass 10.

The disclosed embodiment provides not only the display apparatus having the display 40 described above but also an input device, such as a touch pad that does not provide a function of displaying specific information by the absence of a display 40 but provides a touch input function. The input device differs from the display apparatus in that the display 40 is omitted in FIG. 1. The remaining configuration of the input device is the same as that of the display apparatus, so further description of the input device is omitted.

The display 40 may include a plasma display panel (PDP), a liquid crystal display (LCD) panel, an electroluminescence (EL) panel, an electrophoretic display (EPD) panel, an electrochromic Display (ECD) panel, a light emitting diode (LED) panel, or an organic light emitting diode (OLED) panel, but is not limited thereto. In the disclosed embodiment, the LCD may be used as an example of the display 40.

The touch panel 30 may include transparent electrodes X and Y. The transparent cover glass 10 may be disposed at an upper side of the touch panel 30. The touch panel 30 and the cover glass 10 can be bonded by the OCA layer 20. The cover glass 10 is exposed to the outside of the display apparatus to form an external shape of the display apparatus and protects the internal configuration of the display apparatus. The cover glass 10 may be embodied as a tempered glass or a transparent film.

The tempered glass can be strengthened by heating the formed plate glass to 500° C. to 600° C., which is close to the softening temperature, compression-deforming and tensile-deforming a surface of the heated glass and an interior of the heated glass, respectively, by quenching the heated glass with compressed cooling air. Such tempered glass has 3˜5 times higher bending strength than normal glass, 3˜8 times higher impact resistance than normal glass, and superior heat resistance than normal glass.

The transparent film can be made of a transparent synthetic resin, and is transparent as well as flexible. If the display 40 and a controller 50 described later as well as the cover glass 10 are flexible, the display apparatus may be flexible.

The transparent film may be embodied as a transparent and strong poly methyl methacrylate (PMMA) film or a transparent polycarbonate (PC) film.

The touch panel 30 according to the disclosed embodiment is implemented to detect a touch by a mutual capacitance method among capacitance methods. The disclosed embodiment is not limited thereto, and the touch panel 30 may be implemented to detect the touch in a self-capacitance method. The mutual capacitance type touch panel 30 has a first transparent electrode and a second transparent electrode, which will be described later, and capacitance may be formed between the two transparent electrodes.

When a finger or a touch tool is placed near the two transparent electrodes or touches the touch panel, the value of the capacitance formed between the two transparent electrodes changes. By measuring whether or not the value of the capacitance formed between the two transparent electrodes changes, it may be determined whether the finger or the touch tool contacts the display apparatus.

The transparent electrodes X and Y of the touch panel 30 may be embodied of a metal material through which electricity is conducted or may be embodied of a transparent material so that light incident from the outside is transmitted

The transparent electrodes X and Y include a first transparent electrode X and a second transparent electrode Y. The first transparent electrode and the second transparent electrode may be formed in a specific pattern. A dielectric may be disposed between the first transparent electrode and the second transparent electrode.

The first transparent electrode X and the second transparent electrode Y may be composed of a plurality of lines intersecting with each other. A plurality of intersecting lines may have a linear shape, or may have a structure in which the electrode has a rectangular shape with a large area as shown in FIG. 1. The first transparent electrode and the second transparent electrode may be disposed in the same layer.

The first transparent electrode X and the second transparent electrode Y may be embodied in indium tin oxide (ITO), indium zinc oxide (IZO), or the like, which have high electric conductivity and transmit light in the visible light region.

The first transparent electrode X and the second transparent electrode Y may be embodied in Ag nanowire or carbon nanotube (CNT) having higher electric conductivity and better light transmittance in the visible light region than ITO or IZO.

The first transparent electrode X and the second transparent electrode Y may be embodied in 3,4-ethylenedioxythiophene (PEDOT) or graphene which is transparent enough to transmit 98% or more of light and whose electric conductivity is 100 times or more of copper.

The touch panel 30 and the display 40 may be integrally formed or separately formed and then assembled.

The display apparatus according to the disclosed embodiment may use an Optical Clear Adhesive (OCA) as the adhesive layer 20 for bonding the touch panel 30 and the cover glass 10. Hereinafter, such an adhesive layer is referred to as the optical clear adhesive layer 20.

The OCA layer 20 of the display apparatus according to the disclosed embodiment may include a single layer 21 formed of conductive particles, as shown in FIG. 2A. Examples of the conductive particles include ions.

As shown in FIG. 2B, the OCA layer 20 may include a plurality of layers 23 formed of conductive particles. As shown in FIG. 2C, the conductive particles may be dispersed inside the OCA layer 20.

The conductive particles may be selected as a material that does not hinder the transparency of the OCA layer 20.

As described above, the OCA layer 20 including the conductive particles has a characteristic in which the permittivity is changed corresponding to the pressure operation when a touch command including the pressure operation is applied to the cover glass 10.

In another embodiment, the OCA layer 20 including a polar material such as polyvinylidene fluoride (PVDF) has a characteristic in which the permittivity is changed corresponding to the pressure operation when the touch command including the pressure operation is applied to the cover glass 10 as in the case where conductive particles are included in the OCA layer 20. When a material having a dipole moment value such as a polar material is included, the permittivity of the OCA layer 20 may vary corresponding to the pressure. The polar material may be selected as a material that does not hinder the transparency of the OCA layer 20.

As shown in FIGS. 2A to 2C, the OCA layer 20 may be embodied by including either a conductive particle or a polar material, or may be embodied by including both a conductive particle and a polar material.

As described above, when the OCA layer 20 has the property of changing the permittivity according to the pressure, the display apparatus can identify the touch command including the pressure operation by using this property.

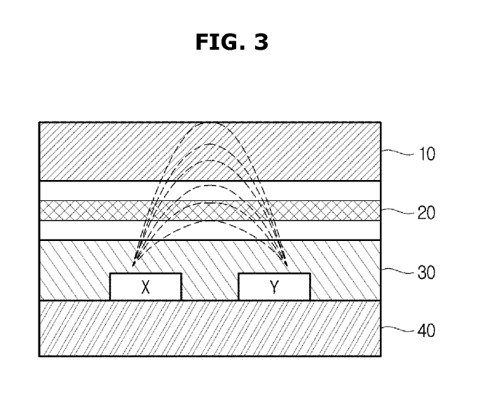

A case in which the touch command without the pressure operation or the touch command including the pressure operation is applied to the display apparatus in accordance with one embodiment of the present disclosure will be described with reference to FIGS. 3 to. 6.

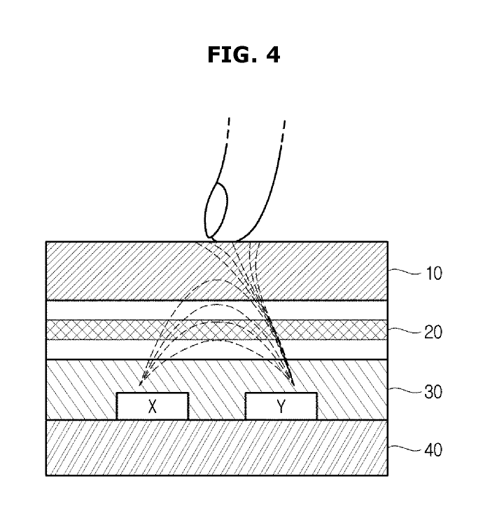

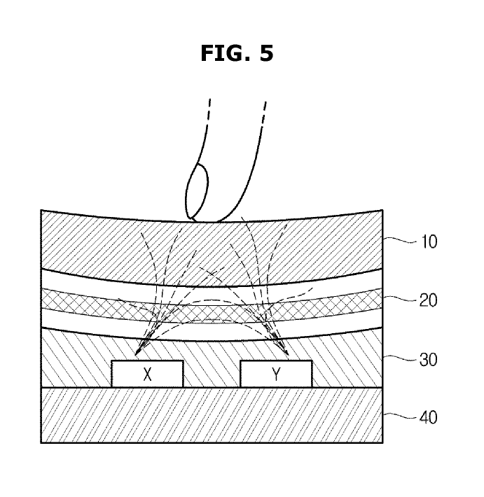

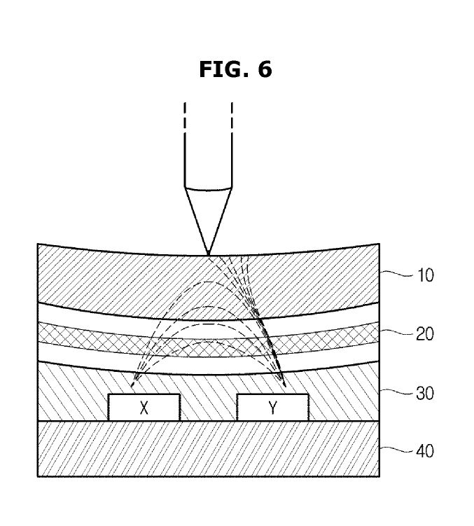

FIG. 3 is a view conceptually illustrating capacitance when a touch command is not inputted to the display apparatus in accordance with one embodiment of the present disclosure. FIG. 4 is a view conceptually illustrating capacitance when a touch command without a pressure operation is input to the display apparatus in accordance with one embodiment of the present disclosure. FIG. 5 is a view conceptually illustrating capacitance when a touch command including the pressure operation is input to the display apparatus in accordance with one embodiment of the present disclosure. FIG. 6 is a view conceptually illustrating capacitance when a pressure operation is input by a non-conductive tool to the display apparatus in accordance with one embodiment of the present disclosure.

In the display apparatus according to the disclosed embodiment, when the touch command is not input, an electric field is formed between the first transparent electrode and the second transparent electrode and capacitance is generated as illustrated in FIG. 3. FIGS. 3 to 6 illustrate the electric field through a dotted line. The display apparatus detects the capacitance formed between the first transparent electrode and the second transparent electrode at a predetermined frequency, and determines that the touch command is not input when the capacitance is not changed.

As illustrated in FIG. 4, when a conductive material, for example, a finger of a person is touched to the cover glass 10, some of the electric field formed between the first transparent electrode and the second transparent electrode are absorbed by the finger, thereby causing a change in the capacitance formed between the first transparent electrode and the second transparent electrode. The display apparatus recognizes the touch command through the change in the capacitance.

As illustrated in FIG. 5, when the finger of the person touches the cover glass 10 and performs a pressure operation to press the cover glass 10, some of the electric field formed between the first transparent electrode and the second transparent electrode are absorbed by the finger, thereby causing a change in the capacitance formed between the first transparent electrode and the second transparent electrode.

The change in the capacitance generated when the touch command including the pressure operation is applied is larger than the change in the capacitance generated when only the touch command illustrated in FIG. 4 is applied. The permittivity of the OCA layer 20 including the conductive particles or the polar material changes corresponding to the application of the pressure, and thus the change in the capacitance is larger than when the touch command is simply applied.

The display apparatus determines that the touch command includes the pressure operation when the change in the capacitance is larger than the predetermined reference value and determines that the touch command is the simple touch command that does not include the pressure operation when the change in the capacitance is less than the predetermined reference value as illustrated in FIG. 4.

The reference value for determining whether or not the touch command includes the pressure operation may be derived through experiments and stored in advance in the storage device of the display apparatus. The storage device may be embodied in a nonvolatile memory device such as a cache, a Read Only Memory (ROM), a Programmable ROM (PROM), an Erasable Programmable ROM (EPROM), an Electrically Erasable Programmable ROM (EEPROM) and Flash memory or a volatile memory device such as a Random Access Memory (RAM) or a storage medium such as a Hard Disk Drive (HDD), a CD-ROM, but is not limited thereto.

When the cover glass 10 of the display apparatus is touched by the non-conductive tool, the capacitance formed between the first transparent electrode and the second transparent electrode does not change. However, when pressure is applied to the cover glass 10 of the display apparatus by the non-conductive tool, as illustrated in FIG. 6, a change occurs in the capacitance formed between the first transparent electrode and the second transparent electrode due to the change of the permittivity of the OCA layer 20.

The display apparatus according to the disclosed embodiment can recognize the pressure operation of the non-conductive tool as a touch. When the change in the capacitance is larger than the reference value described above due to the increase in the pressure by the non-conductive tool, the display apparatus may recognize the pressure operation of the non-conductive tool as the pressure operation. The display apparatus according to the disclosed embodiment may recognize the pressure operation of the non-conductive tool as the pressure operation when the change in the capacitance due to the pressure of the non-conductive tool is larger than the reference value, and recognize the pressure operation of the non-conductive tool as the touch when the change in the capacitance due to the pressure of the non-conductive tool is less than the reference value.

According to the disclosed embodiment, the display apparatus including the OCA layer 20 whose permittivity varies with pressure, may detect pressure operation by the non-conductive tool.

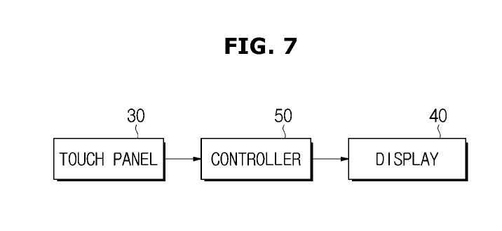

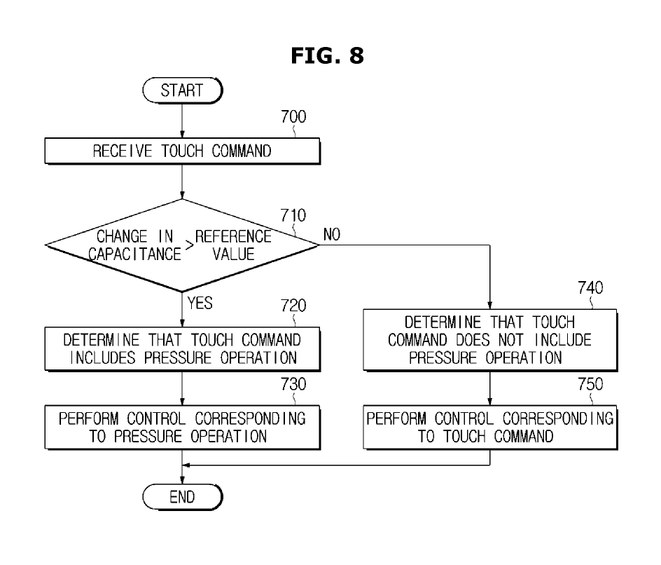

The controller 50 controls the display apparatus by comparing the change in the capacitance of the touch panel 30 with the reference value. Hereinafter, the controller 50 is described in detail with reference to FIGS. 7 and 8. FIG. 7 is a block diagram illustrating a control configuration of the display apparatus in accordance with one embodiment of the present disclosure.

As illustrated in FIG. 7, the controller 50 of the display apparatus according to the disclosed embodiment controls the display of the display 40 based on the change in the capacitance occurring in the touch panel 30.

The controller 50 may be implemented as a storage device that stores an algorithm for controlling operations of components in the display apparatus or the input device or data for a program that reproduces the algorithm, and a processor that performs the above-described operations using data stored in the storage device. The storage device may be implemented with at least one of the above-described storage media and may be implemented as a chip separate from the processor. Alternatively, the storage device and the processor may be implemented as a single chip.

The controller 50 detects the change in the capacitance of the touch panel 30 at a predetermined frequency, and determines that the touch command is not input when the capacitance is not changed.

When the capacitance of the touch panel 30 is changed, the controller 50 may determine that the touch command is input when the change in the capacitance is less than the reference value. As illustrated FIG. 4, when a finger of a person is touched to the cover glass 10, some of the electric field formed between the first transparent electrode and the second transparent electrode are absorbed by the finger, thereby causing the change in the capacitance formed between the first transparent electrode and the second transparent electrode.

The controller 50 may determine that the touch command is input when the change in the capacitance is less than the reference value described above. The controller 50 may change the display of the display 40 by performing control corresponding to the input touch command. For example, when a touch command for a specific icon is input, the controller 50 may execute an application corresponding to the touched icon.

The controller 50 may determine that the touch command including the pressure operation is input when the change in the capacitance is larger than the reference value. As illustrated in FIG. 5, when the finger of the person touches the cover glass 10 and performs a pressure operation to press the cover glass 10, some of the electric field formed between the first transparent electrode and the second transparent electrode are absorbed by the finger, thereby causing the change in the capacitance formed between the first transparent electrode and the second transparent electrode.

The change in capacitance generated when the touch command including the pressure operation is applied is larger than the change in the capacitance generated when only the touch command shown in FIG. 4 is applied. The permittivity of the OCA layer 20 including the conductive particles or the polar material changes corresponding to the application of the pressure, and thus the change in capacitance is larger than when the touch command is simply applied. The display apparatus determines that the touch command includes the pressure operation when the change in capacitance is larger than the predetermined reference value.

The controller 50 may change the display of the display 40 by performing control corresponding to the touch command including the pressure operation. The command corresponding to the touch command including the pressure operation may be stored in advance in a command different from the command corresponding to the touch command without the pressure operation. Further, among the pressure operation, another command may be performed depending on the degree of pressure, that is, depending on the degree of change in the capacitance.

The storage device may store commands corresponding to the pressure operation in advance, and may store different types of commands classified according to the degree of change in the capacitance due to the pressure operation. For example, when a touch command including a pressure operation for a specific icon is input, the controller 50 determines that a command of a type different from a simple touch command is input and may perform different kinds of control as opposed to executing an application corresponding to the icon when a simple touch command is input. Further, when the pressure becomes stronger, the controller 50 may determine that another kind of command is input, and perform another control.

FIG. 8 is a flowchart illustrating a method of controlling the display apparatus in accordance with one embodiment of the present disclosure.

As illustrated in FIG. 8, when a touch command is received (700), the controller 50 determines whether the change in the capacitance is larger than the reference value (710). When the change in the capacitance is larger than the reference value, the controller 50 determines the received touch command as a touch command including the pressure operation (720) and performs control corresponding to the touch command including the pressure operation (730).

The controller 50 detects the change in the capacitance of the touch panel 30 at a predetermined frequency, and determines that the touch command is not input when the capacitance is not changed.

When the capacitance of the touch panel 30 is changed, The controller 50 may determine that the touch command including the pressure operation is input when the change in the capacitance is larger than the reference value. As illustrated in FIG. 5, when the finger of the person touches the cover glass 10 and performs a pressure operation to press the cover glass 10, some of the electric field formed between the first transparent electrode and the second transparent electrode are absorbed by the finger, thereby causing the change in the capacitance formed between the first transparent electrode and the second transparent electrode.

The change in the capacitance generated when the touch command including the pressure operation is applied is larger than the change in the capacitance generated when only the touch command shown in FIG. 4 is applied. The permittivity of the optical clear adhesive layer 20 including the conductive particles or the polar material changes corresponding to the application of the pressure, and thus the change in the capacitance is larger than when the touch command is simply applied. The display apparatus determines that the touch command includes the pressure operation when the change in the capacitance is larger than the predetermined reference value.

The controller 50 may change the display of the display 40 by performing control corresponding to the touch command including the pressure operation. The command corresponding to the touch command including the pressure operation may be stored in advance in a command different from the command corresponding to the touch command without the pressure operation.

When a pressure operation having a different magnitude of pressure is input, another command may be performed depending on the degree of change in the capacitance corresponding thereto. For example, when a touch command including a pressure operation for a specific icon is input, the controller 50 determines that a command of a type different from a simple touch command is input and may perform different kinds of control as opposed to executing an application corresponding to the icon when a simple touch command is input. Further, when the pressure becomes stronger, the controller 50 may determine that another kind of command is input, and perform another control.

When the change in the capacitance is less than the reference value, the controller 50 determines that the pressure operation is not included in the received touch command (740) and performs control corresponding the received touch command (750).

When the capacitance of the touch panel 30 is changed, the controller 50 may determine that the touch command is input when the change in the capacitance is less than the reference value. As illustrated FIG. 4, when a finger of a person is touched to the cover glass 10, some of the electric field formed between the first transparent electrode and the second transparent electrode are absorbed by the finger, thereby causing the change in the capacitance formed between the first transparent electrode and the second transparent electrode.

The controller 50 may determine that the touch command is input when the change in the capacitance is less than the reference value described above. The controller 50 may change the display of the display 40 by performing control corresponding to the input touch command. For example, when a touch command for a specific icon is input, the controller 50 may execute an application corresponding to the touched icon.

As is apparent from the above description, according to the proposed display apparatus, it may be possible to sense the pressure applied to the display device without a separate sensor for sensing the pressure.

Since a separate sensor for sensing the pressure is not required, the production cost of the display apparatus can be reduced.

Since a separate sensor for sensing the pressure is not required, the structure of the display apparatus can be further simplified and thinned.

It may be possible to apply the display apparatus to a device requiring a large-area display such as a tablet computer or a laptop computer.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A display apparatus comprising:
a touch panel;
a cover glass disposed at an upper side of the touch panel;
a display disposed at a lower side of the touch panel; and
an optical clear adhesive (OCA) layer disposed between the touch panel and the cover glass to bond the touch panel and the cover glass,
wherein a permittivity of the OCA layer is changed when a pressure is applied.

2. The display apparatus according to claim 1, wherein the OCA layer comprises at least one layer comprising conductive particles so that the permittivity is changed when the pressure is applied.

3. The display apparatus according to claim 1, wherein the OCA layer comprises conductive particles dispersed therein so that the permittivity is changed when the pressure is applied.

4. The display apparatus according to claim 1, wherein the OCA layer comprises a polar material so that the permittivity is changed when the pressure is applied.

5. The display apparatus according to claim 1, wherein the OCA layer comprises a polyvinylidene fluoride (PVDF) so that the permittivity is changed when the pressure is applied.

6. The display apparatus according to claim 1, further comprising a controller, when a touch command for the cover glass is input, configured to determine the touch command as a touch command comprising the pressure operation when a change in the capacitance of the touch panel is larger than a predetermined reference value, and determine the touch command as a touch command without the pressure operation when the change in the capacitance of the touch panel is less than the predetermined reference value.

7. The display apparatus according to claim 6, wherein when the touch command is determined to be the touch command comprising the pressure operation, the controller, in response to the pressure operation, is configured to perform a predetermined control different from a control according to the touch command without the pressure operation.

8. A method for controlling a display apparatus comprising:
determining whether a change in capacitance of a touch panel of the display apparatus is larger than a predetermined first reference value when a touch command to the display apparatus is input; and
determining the touch command as a touch command comprising a pressure operation when the change in the capacitance is larger than the first reference value.

9. The method according to claim 8, further comprising performing a predetermined control in response to the pressure operation when the touch command is determined to be the touch command comprising the pressure operation.

10. The method according to claim 8, further comprising performing a predetermined control, in response to the pressure operation, different from a control according to the touch command without the pressure operation when the touch command is determined to be the touch command comprising the pressure operation.

11. The method according to claim 8, further comprising determining the touch command as a touch command without a pressure operation when the change in the capacitance is less than the first reference value.

12. An input apparatus comprising:
a touch panel;
a cover glass disposed at an upper side of the touch panel; and
an optical clear adhesive (OCA) layer disposed between the touch panel and the cover glass to bond the touch panel and the cover glass,
wherein a permittivity of the OCA layer is changed when a pressure is applied.

13. The input apparatus according to claim 12, wherein the OCA layer comprises at least one layer comprising conductive particles so that the permittivity is changed when the pressure is applied.

14. The input apparatus according to claim 12, wherein the OCA layer comprises conductive particles dispersed therein so that the permittivity is changed when the pressure is applied.

15. The input apparatus according to claim 12, wherein the OCA layer comprises a polar material so that the permittivity is changed when the pressure is applied.

16. The input apparatus according to claim 12, wherein the OCA layer comprises a polyvinylidene fluoride (PVDF) so that the permittivity is changed when the pressure is applied.
